(19) United States
(12) Patent Application Publication
(10) Pub. No.: US 2011/0115708 A1
(43) Pub. Date: May 19, 2011

(54) WIRELESS INPUTTING DEVICE

(75) Inventor: Chien-Hsin LEE, Sanchong City (TW)

(73) Assignees: SILITEK ELECTRONIC (GUANGZHOU) CO., LTD., Guangzhou (CN); LITE-ON TECHNOLOGY CORPORAITON, Taipei City (TW)

(21) Appl. No.: 12/779,176

(22) Filed: May 13, 2010

(30) Foreign Application Priority Data
Nov. 17, 2009 (CN) 200920279359.1

(51) Int. Cl. G06F 3/033

(52) U.S. Cl. 345/163

(57) ABSTRACT

A wireless inputting device includes an operating device and a receiver for receiving wireless signals from the operating device. The operating device has a main housing. The main housing has an opening, an accommodating space concaved inwardly from the opening, and a covering lid covered on the opening. The covering lid has a retaining mechanism formed on an inner side thereof and protruded toward the accommodating space. The receiver is held by the retaining mechanism on the covering lid and is received in the accommodating space. When the covering lid retained the receiver and covered, the receiver with the assistance of another concise mechanism props inwardly against a power switch in the operating device to cut off power.

### BACKGROUND OF THE INVENTION

1. Field of the Invention

The invention described here relates to a wireless inputting device, particularly to a wireless inputting device, which engages and has a wireless transmitting/receiving interface; also engaging and carrying a wireless signal receiver, through which receiver, allows users to input signals without the inconvenience of cables or wires yet still access, remotely yet while in proximity, and control or otherwise operate electronic devices, including those such as computers, game machines, and others of adaptable like kind.

2. Description of Related Art

The peripherals for computers, such as mice, keyboards, joysticks, or presenters, are developed toward wireless, so that users, their movement and work or play areas are not limited by cables. To achieve the purpose of wireless operation, a wireless inputting device usually includes a wireless transmitting/receiving interface, which is built therein for transmitting and receiving wireless signals, and a wireless signal receiver, which may be within or attached to the computer for receiving the wireless signals.

A couple of problems in the conventional wireless inputting device need solutions to enhance their usefulness would, ideally, be resolved. Significant difficulties among these include: 1) minimizing consumption of battery power to make it worthwhile to advantageously use and enjoy the wire/cable-free mouse or other peripheral and maximize battery life for the wireless device; and 2) solution of the inconvenience, frustration, and irritation of loss of valuable time through misplacement or outright loss of a wireless signal receiver when it and the wireless peripheral are being moved to other locations or to storage.

Furthermore, since the wireless inputting devices such as mice, keyboards . . . etc., are low price products, additional high production costs are beneficially avoided during design and manufacture of such the wireless inputting devices.

### SUMMARY OF THE INVENTION

With view of these issues, annoyances, and inconveniences, this invention provides a wireless inputting device provides convenient accommodation, through well-engineered mechanisms for holding such beneficial of battery power during use as well as convenient, stable, and secure receiver within the body of the inputting device, as well as avoiding additional high production costs while minimizing the likelihood of loss of the signal receiver and batteries as they are stored within the device.

By provision of added convenience and well-considered design, the present invention provides a wireless inputting device, wherein power supplied to the wireless inputting device is able to be switched-off through both the receiver itself as well as when the receiver is secured in the wireless inputting device. Therefore, it unnecessary power consumption is prevented, and thereby enhancing overall battery life.

To achieve the above-mentioned objectives, the present invention provides a wireless inputting device, which includes an operating device and a receiver being attachable to a host for receiving wireless signals from the operating device. The operating device has a main housing. The main housing has an opening, an accommodating space concaved inwardly from the opening, and a covering lid covered on the opening. The covering lid has a retaining mechanism formed on an inner side thereof and protruded toward the accommodating space. The receiver is held by a retaining mechanism on the covering lid and is received in the accommodating space.

To achieve another above-mentioned objective, the present invention provides a wireless inputting device, wherein the main housing has a plurality of partitions to define the accommodating space. One of the partitions is integrally formed with a springy arm and a slit is surrounded the springy arm. Therefore, the springy arm is pressed to contact elastically a power switch in the main housing for cutting off power after the receiver is received in the accommodating space.

Still other aspects, features, and attendant advantages of the present invention will become apparent to those skilled in the art from a reading of the following detailed description of embodiments constructed in accordance therewith, taken in conjunction with the accompanying drawings.

### BRIEF DESCRIPTION OF THE DRAWINGS

FIG. 1 is an exploded perspective view of a wireless inputting device of the present invention;

FIG. 2 is another exploded perspective view of the wireless inputting device of the present invention;

FIG. 3 is an assembled perspective view of the wireless inputting device of the present invention;

FIG. 4 is a perspective view of the wireless inputting device covered with a covering lid of the present invention;

FIG. 5 is a cross-sectional view of the wireless inputting device along line 5-5 in FIG. 3 representing a view of this invention;

FIG. 5A is a cross-sectional view of the wireless inputting device of another example along line 5-5 in FIG. 3 of the present invention;

FIG. 6 is a perspective view of the wireless inputting device of a second embodiment of the present invention;

FIG. 7 is a plane view of a covering lid of a second embodiment according to the present invention;

FIG. 7A is a cross-sectional view of the covering lid of the second embodiment according to the present invention;

FIG. 8 is a partial cross-sectional view of the covering lid of a third embodiment according to the present invention;

FIG. 9 is a partial cross-sectional view of the covering lid of a fourth embodiment according to the present invention; and

FIG. 10 is a partial cross-sectional view of the covering lid of a fifth embodiment according to the present invention.

### DETAILED DESCRIPTION OF THE PREFERRED EMBODIMENTS

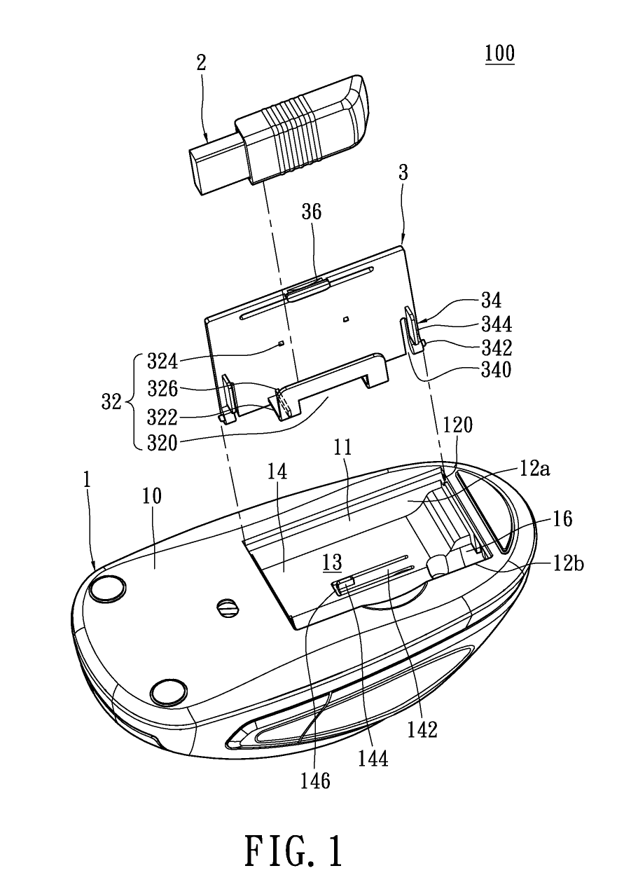

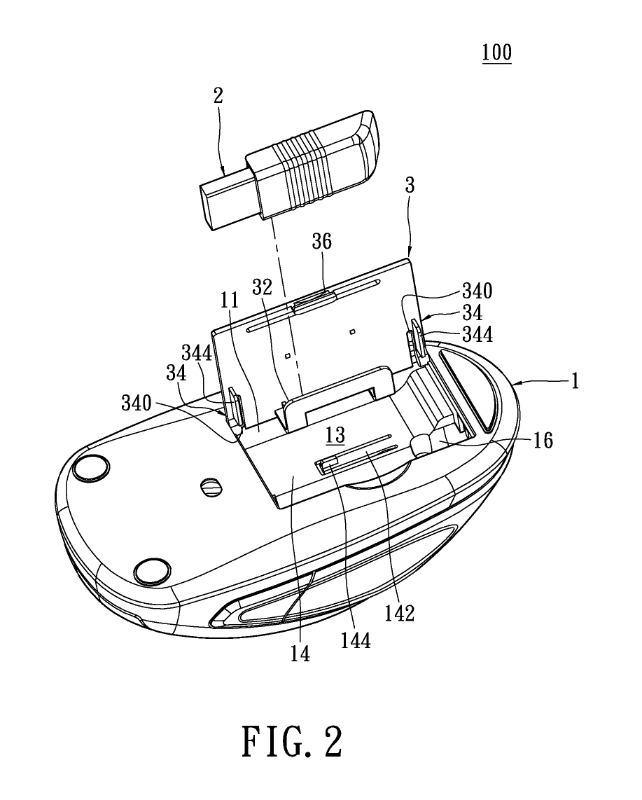

Referring is made to FIG. 1 to FIG. 3. In this embodiment, a wireless mouse is illustrated according to the present invention. However, the characteristics of the wireless inputting device disclosed in the present invention could be applied to other computer peripherals such keyboards, game controller, joystick . . . etc. The wireless inputting device 100 includes an operating device 1, a receiver 2 attached to a host for receiving wireless signals from the operating device 1, and a covering lid 3. In this embodiment, the receiver 2 is equipped with an USB (Universal Serial Bus) interface; however it can adapt other interface, such as IEEE 1394.

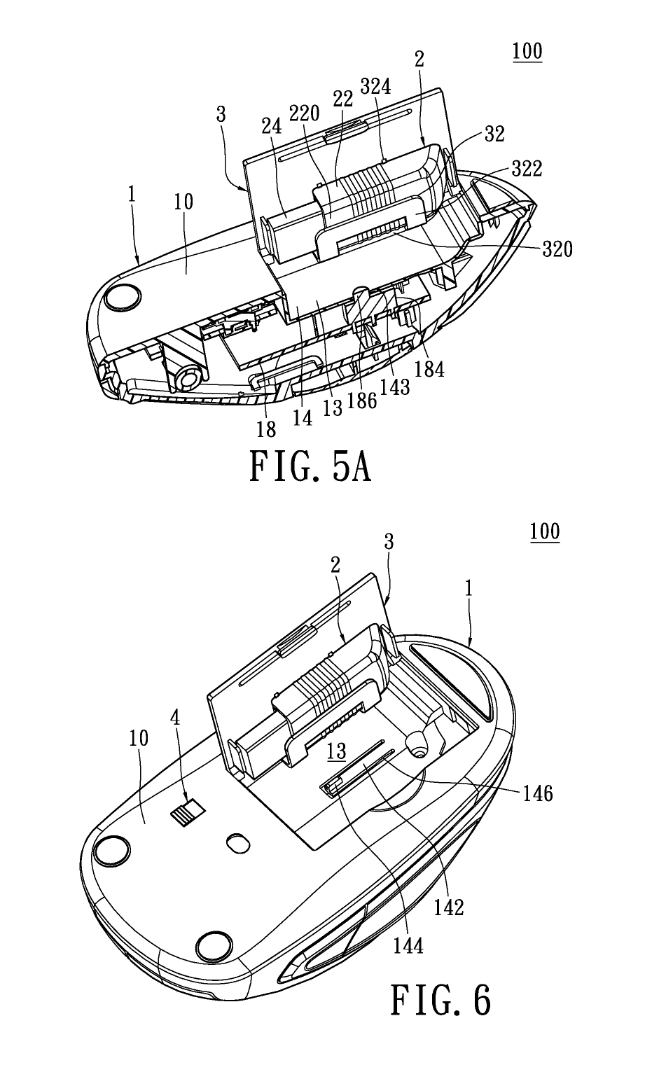

The operating device 1 includes a main housing 10 and a printed circuit board 18 which is received in the main housing 10 (as shown FIG. 5). The main housing 10 has an opening 11 and an accommodating space 13 which is concaved inwardly from the opening 11. The opening 11 has a contour substantially equal to the covering lid 3, so that the opening 11 could be covered up by the covering lid 3. The accommodating space 13 is defined by a plurality of partitions extended from the main housing 10. In this embodiment, the main housing 10 includes at least two side partitions 12a, 12b which are extended inwardly from an edge of the opening 11 (as shown in FIG. 1), and a bottom partition 14 connected to both of the side partitions 12a, 12b, so that the accommodating space 13 is defined therein. The opening 11 of this embodiment is formed at the bottom of the main housing 10, but it can be located at different places according to requirements. For example, if the present invention is applied to a wireless keyboard, the opening can be located at the top face of the housing of the wireless keyboard so that the receiver can be conveniently taken.

The covering lid 3 has a retaining mechanism 32 which is protruded toward the accommodating space 13 from one side of the covering lid 3, when the covering lid 3 is covered on the opening 10. The retaining mechanism 32 of the present invention is used to hold the receiver 2 on the covering lid 3, so that the receiver 2 would be received in the accommodating space 13. Furthermore, in a preferred embodiment, the accommodating space 13 of the main housing 10 is provided with a space to receive battery. For example, the accommodating space 13 of this embodiment is formed with a battery receiving area 16. Thus, both the receiver 2 and the battery (not shown) could be received in the same one accommodating space 13. In other word, the covering lid 3 of the present invention also could be as a battery cover for battery, and an additional covering lid is not required.

Concerning the way of the covering lid 3 connected to the opening 11, it would be pivoted or wedged way. In this embodiment, the covering lid 3 is pivotally connected to the main housing 10. Please refer to FIG. 1. The covering lid 3 has a pair of pivoting hinge-pins 342 protruding from two sides thereof. The side partition 12a of the main housing 10 is formed with a pair of hinge-pins receiving holes 120 in correspondence with the pivoting hinge-pins 342. Thus the covering lid 3 can be pivotally connected to the opening 11. For the purpose of convenient assembly and disassembly, the covering lid 3 has a pair of slots 340 and a pair of flexible portions 34 formed at an outer side of the slots 340, which provide sufficient flexibility to insert the pivoting hinge-pins into the hinge-pins receiving holes 120 so that the spring-tension of the material allows for articulation of the cover. The slots, and additional ones in the cover are also available to provide some level of heat dissipation. The slot 340 could be rectangular shaped as shown in this embodiment, or polygon shaped, such as U-shape, half-moon shape, or arc shape. The pair of slots 340 respectively are adjacent to two sides of the covering lid 3 and are located at an inner side of the pair of pivoting hinge-pins 342. The pivoting hinge-pins 342 project outwardly from the outer end of the pair of flexible portions 34 respectively. Thus, the covering lid 3 can be separated from the main housing 10 when pushing the pair of flexible portions 34 inwardly. The covering lid 3 has a hook 36 protruded from an inner side thereof. The hook 36 is opposite to the pivoting hinge-pins 342 and is close to an outer edge of the covering lid 3 for being wedged in the opening 11 of the main housing 10.

The retaining mechanism 32 of the present invention is used to retain the receiver 2 at the inner side of the covering lid 3, which is preferably formed on the inner side of the covering lid 3 integrally. In this embodiment, the retaining mechanism 32 includes a clip 322 (being made of a material providing spring-like tension/pressure to secure the receiving unit or receiver within the peripheral device) and a pair of fixing, holding, guiding, positioning nibs 324; which could also be formed as a raised “fence” or “bead”, to assist in holding the receiver in a fully retained position. The clip 322 is generally L-shaped from a side view, which is used to hold the receiver 2. The clip 322 is able to be made in differing designs or shapes, including for example, a generally “U-shaped clip” with one truncated leg; which could be envisioned as an uppercase “L” having a serif at the distal end of the shorter leg. The fixing nibs 324 prop against one side of the receiver 2 and cooperate with the clip 322 to hold the receiver 2 firmly while the peripheral device is not in use. The quantity of the fixing nib 324 could be at least one. The clip 322 further includes a cutout 320 for users to push the receiver 2 out of the clip 322 conveniently. Reference is made to FIG. 1. The retaining mechanism 32 further includes a fixing board 326 to fix the receiver 2 therein. In this embodiment, the covering lid 3 further includes a pair of spacing portions 344 formed on an inner side thereof, which is used to block the sides of the receiver 2. The spacing portions 344 are disposed according to the length of the receiver 2, which are respectively located on the pair of flexible portions 34 in this embodiment.

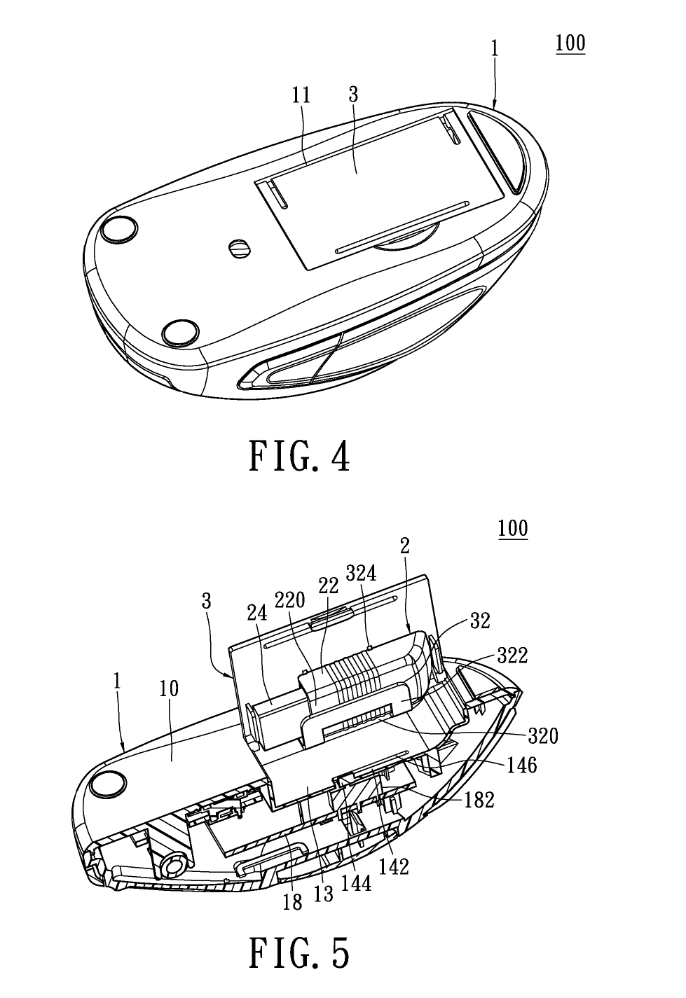

Reference is made to FIGS. 4 and 5, in which a perspective view of the wireless inputting device 100 in which the inner cavity is covered with the covering lid 3 according to the present invention is illustrated. The wireless inputting device 100 of the present invention uses a simple mechanism, which is placed on the inner side of the covering lid 3, to removably hold the receiver 2 in place. In addition, the covering lid 3 serves as a battery cover and retainer. Further, the receiver 2 is fully secured in the accommodating space 13 and is held closely on the underside of the covering lid 3, to protect from damage through dropping or other impact or undue pressure, as well as simply protecting against separation of the two units or other annoying or embarrassing loss.

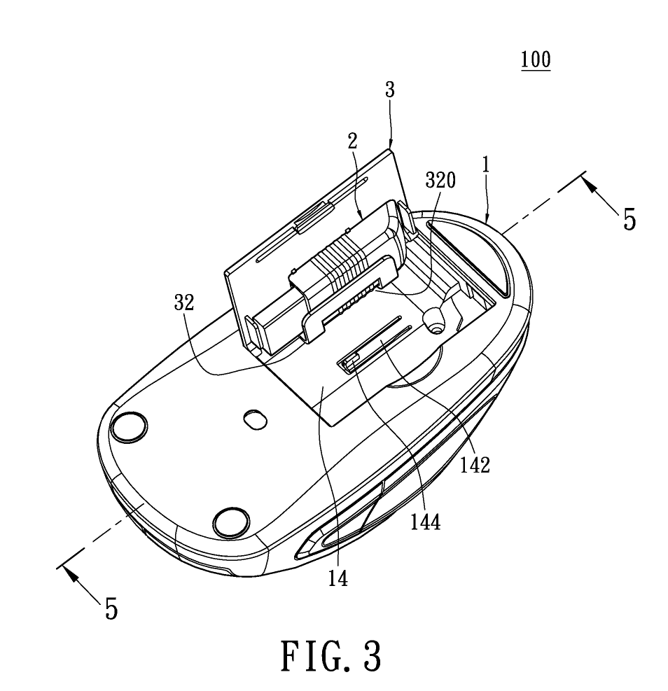

Reference is made to FIG. 5, in which a cross-sectional view of the wireless inputting device, along line 5-5 as seen in FIG. 3, according to the present invention is illustrated.

The present invention further has a characteristic of avoiding unnecessary electricity consumption to enhance the useful life of the battery. This is achieved by both the receiver 2 and another concise mechanism when the receiver 2 is received. The bottom partition 14 has a springy arm 142 formed integrally thereon and a slit 146 which is surrounded the springy arm 142. The springy arm 142 contacts elastically a power switch 182 on the printed board 18 received in the main housing 10. The power switch 182 in this embodiment is a micro switch which actuates by very little physical force. Other switches with similar function may be adapted. The power switch 182 is available to control the power of the operating device 1. The detailed actuation follows: the springy arm 142 has a contact block 144 on a free end thereof. When the covering lid 3 retained the receiver 2 and is covered on the opening 11, the receiver 2 has a main body 22 with a side wall 220 which presses inwardly against the contact block 144, which then presses inward against power switch 182 on the printed board 18. Therefore, the present invention is enabled in cutting power in the operating device 1 through a simple mechanism in the accommodating space 13 of the main housing 10 and through the springy arm 142 on the bottom partition 14. When the receiver 2 is secured on the underside of the hinged cover and rotated into the accommodating space 13, the main body 22 of the receiver 2 simultaneously presses the springy arm 142 to actuate the power switch 182; thereby stopping loss of battery power to enhance battery life—a goal of this invention.

The above embodiment illustrates the present invention, which utilizes the receiver 2 with the simple, though unobvious mechanism provided in the accommodating space 13 to reduce unnecessary consumption of electrical power. It is worthy of mention that the springy arm 142, which is formed on the bottom partition 14, is simply a preferred embodiment for matching with the printed board 18. The springy arm could be formed alternatively in other convenient locations to needs for positioning of the power switch and the printed board are considered and determined; including, the side partitions 12a, 12b. It is to be recognized that the springy arm is only one embodiment of the mechanism to prevent unnecessary power loss and accomplish enhancement of batter life. Alternative embodiments of this simple mechanism according to the present invention are illustrated below.

Reference is made to FIG. 5A, in which a cross-sectional view of the wireless inputting device along line 5-5 in FIG. 3 of second embodiment according to the present invention is illustrated. In this embodiment, the bottom partition 14 is formed with a hole 143. The printed board 18 is provided with a power switch 184. The power switch 184 has a button 186 which is exposed outside the hole 143. When the covering lid 3, which held the receiver 2, is turned to cover the opening 11, the side wall 220 of the main body 22 of the receiver 2 presses inwardly against the button 186 of the power switch 184. Therefore, the present invention could cut off the power of the operating device 1 by the concise mechanism, which is the hole 143 formed on the bottom partition 14 of the main housing 10 with the button 186. When the receiver 2 is received and turned into the accommodating space 13, the main body 22 of the receiver 2 pushes down the power switch 184 directly to cut off the power of the operating device 1. Thus the electrical power is saved to avoid unnecessary consumption, and the purpose of enhance the useful life of the battery is achieved. Likewise, the hole in this embodiment can be formed on any one of partitions, such bottom partition or side partition, and the button 186 of the power switch 184 could be exposed outside the side partition 12a, 12b.

Reference is made to FIG. 6, in which a perspective view of the wireless inputting device of a second embodiment according to the present invention is illustrated. To allow users can manually cut off the power of the operating device 1, such as the wireless inputting device is used to the desktop computer, the receiver 2 does not need to be received therein to push the power switch 182. The wireless inputting device 100 of the present invention can further has a manual switch 4 on the bottom of the main housing 10 to cut off power manually. The manual switch 4 could electrically connect to the printed board and is severed as a power mater switch.

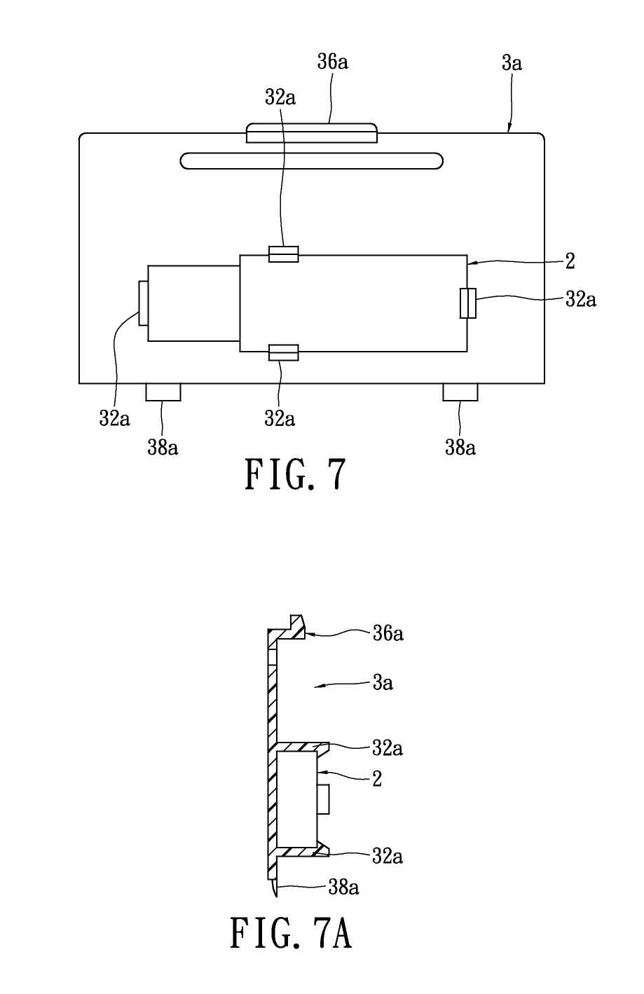

References are made to FIG. 7 and FIG. 7A, a plane view and a cross-sectional view of a covering lid of second embodiment according to the present invention are illustrated. In this embodiment, the covering lid 3a has a retaining mechanism, which is composed of a plurality of clipping tabs 32a. Besides the hooks 36a, the covering lid 3a further includes a pair of wedging tabs 38a opposite to the hook 36a. The pair of wedging tabs 38a is wedged into the edge of the opening 11, then the hook 36a is pressed downwards to cover the opening 11. This embodiment illustrates that the covering lid 3a covered the operating device 1 in a wedging way.

The following embodiments are illustrated how the covering lid of the present invention retains the receiver.

Referring is made to FIG. 8, in which a partial cross-sectional view of the covering lid of a third embodiment according to the present invention is illustrated. In this embodiment, a receiver 2b is provided with an L-shaped retaining portion 26b. And, a covering lid 3b has a holding portion 32b which is formed on an inner surface thereof. The retaining portion 26b of the receiver 2b passes through the holding portion 32b, thus the receiver 2b is firmly held on the covering lid 3b.

Referring is made to FIG. 9, in which a partial cross-sectional view of the covering lid of a fourth embodiment according to the present invention is illustrated. In this embodiment, a receiver 2c is provided with a holding portion 26c. And, a covering lid 3c has an L-shaped retaining portion 32c. The retaining portion 32c passes through the holding portion 26c, thus the receiver 2c is firmly held on the covering lid 3b.

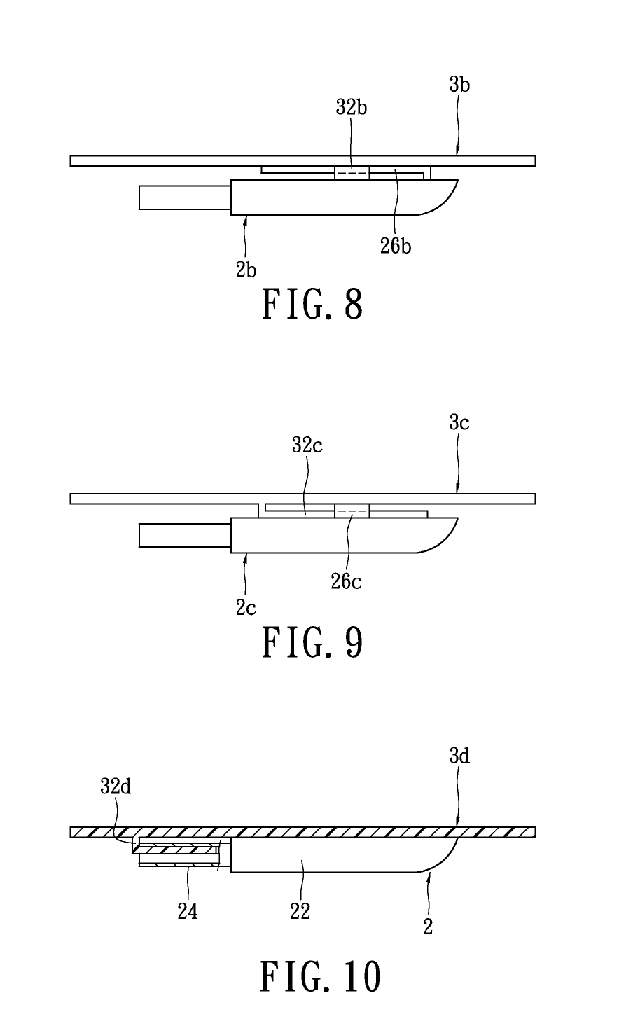

Referring is made to FIG. 10, in which a partial cross-sectional view of the covering lid of a fifth embodiment according to the present invention is illustrated. In this embodiment, a covering lid 3d has an L-shaped retaining portion 32d which is formed on an inner surface thereof. The retaining portion 32d inserts into a plugging portion 24 which is located at a front end of the receiver 2, thus the receiver 2 is held on the covering lid 3d.

The present invention has the advantages as follows. The concise mechanism is provided on the inner side of the covering lid 3 for receiving the receiver 2, thus high additional cost of production is avoid. Besides, the receiver 2 is fully received in the accommodating space 13 and is covered by the covering lid 3, the receiver 2 is certainly secured in the operating device 1 firmly to avoid accidental fall outside because of colliding or squeezing. Furthermore, the receiver 2 and another concise mechanism, the springy arm 142 provided in the present invention, could cut off the power of the operating device 1 when the receiver 2 is received therein. Therefore, it would avoid unnecessary power consumption and enhance the useful life of the battery.

The above descriptions represent preferred embodiments of the present invention, without any intention to limit the scope of the present invention thereto. Various equivalent changes, alterations or modifications based on the claims of this invention are all consequently viewed as being encompassed within the scope of this invention as fully described only in the following claims.

What is claimed is:

1. A wireless inputting device, comprising:
an operating device having a main housing which includes an opening and an accommodating space concaved inwardly from the opening;
a receiver, being attachable to a host for receiving wireless signals from the operating device; and
a covering lid, covering the opening, the covering lid having a retaining mechanism formed on an inner side thereof and projecting toward the accommodating space when the covering lid covers the opening, wherein the receiver is secured by the retaining mechanism on the covering lid and is received in the accommodating space as the covering lid closes.

2. The wireless inputting device according to claim 1, wherein the covering lid is pivotally connected to the main housing, the covering lid has a pair of pivoting hinge-pins extending outwardly from two sides thereof, the main housing has a pair of hinge-pins receiving holes in correspondence with the pair of pivoting hinge-pins.

3. The wireless inputting device according to claim 2, wherein the covering lid further includes a pair of slots respectively being adjacent to the pair of pivoting hinge-pins and a pair of flexible portions formed at outer sides of the slots respectively, wherein the pair of pivoting hinge-pins are located at ends of the pair of flexible portions.

4. The wireless inputting device according to claim 1, wherein the retaining mechanism includes a clip for retaining the receiver and at least one fixing nib for propping against one side of the receiver.

5. The wireless inputting device according to claim 1, wherein the receiver is formed with an L-shaped retaining portion, and the covering lid has a holding portion formed on an inners side thereof, wherein the retaining portion passes through the holding portion for holding the receiver on the covering lid.

6. The wireless inputting device according to claim 1, wherein the covering lid has an L-shaped retaining portion formed on an inners side thereof, and the receiver has a holding portion, wherein the retaining portion passes through the holding portion for holding the receiver on the covering lid.

7. The wireless inputting device according to claim 1, wherein the covering lid has an L-shaped retaining portion formed on an inners side thereof, and the retaining portion inserts into a plugging portion of the receiver located at a front end thereof, thereby holding the receiver on the covering lid.

8. The wireless inputting device according to claim 1, wherein the accommodating space of the main housing further receives a battery therein.

9. The wireless inputting device according to claim 1, wherein the main housing has a plurality of partitions to define the accommodating space, one of the partitions is integrally formed with a springy arm and a slit is surrounded the springy arm, wherein the springy arm is pressed to contact elastically a power switch in the main housing so as to cut off power after the receiver is received in the accommodating space.

10. The wireless inputting device according to claim 9, wherein the main housing includes at least two side partitions extending inwardly from an edge of the opening and a bottom partition connected to the side partitions, wherein the springy arm is formed on the bottom partition and has a contact block, wherein the receiver presses inwardly against the contact block of the springy arm, and the contact block presses against the power switch.

11. The wireless inputting device according to claim 1, wherein the main housing includes a plurality of partitions to define the accommodating space, one of the partitions is formed with a hole, the operating device has a power switch received therein, and the power switch has a button exposed outside the hole, thereby, when the covering lid retains the receiver and is covered on the opening, a main body of the receiver presses inwardly against the button of the power switch so as to cut off power.
